(19) United States
(12) Patent Application Publication
(10) Pub. No.: US 2026/0124690 A1
(43) Pub. Date: May 7, 2026

(54) MANUFACTURING GEARS WITH TIP AND/OR ROOT RELIEF

(71) Applicant: THE GLEASON WORKS, Rochester, NY (US)

(72) Inventor: Hermann J. Stadtfeld, Mandersheid (DE)

(21) Appl. No.: 19/118,418

(22) PCT Filed: Oct. 20, 2023
(86) PCT No.: PCT/US2023/077385

§ 371 Date: Apr. 4, 2025

Related U.S. Application Data
(60) Provisional application No. 63/381,145, filed on Oct. 27, 2022.

(51) Int. Cl. B23F 19/00; B23F 5/02; B23F 15/06; B23F 17/00

(52) U.S. Cl. CPC B23F 19/002; B23F 5/02; B23F 15/06; B23F 17/001

(57) ABSTRACT

A method of producing a tooth profile surface on a workpiece. The method comprises providing a gear cutting tool and rotating the gear cutting tool about an axis of rotation. The cutting tool and workpiece are engaged with one another and rolled together in accordance with a generating roll to generate a profile surface of a tooth. The generating roll comprises a first ratio-of roll and a second ratio-of-roll with the first and second ratios-of-roll being different from one another and with one of the first ratio-of-roll and the second ratio-of-roll resulting in a relief section being formed on the tooth profile surface.

### FIELD OF THE INVENTION

The present invention is directed to the manufacture of gears, particularly straight bevel gears, and to providing tip and/or root relief on the tooth surface of the gears.

### BACKGROUND OF THE INVENTION

In the production of gears, especially bevel gears, two types of processes are commonly employed, generating processes and non-generating processes. Either process can be divided into two categories, face milling (intermittent indexing) where one tooth slot is formed with each plunge of the tool, and face hobbing (continuous indexing) wherein the tool and workpiece rotate in a timed relationship and the tool is fed to depth thereby forming all tooth slots in a single plunge of the tool.

In a generating process, a rotating tool is fed into the workpiece to a predetermined depth. Once this depth is reached, the tool and workpiece are then rolled together in a predetermined relative rolling motion, known as the generating roll, as though the workpiece were rotating in mesh with a theoretical generating gear, the teeth of the theoretical generating gear being represented by the stock removing surfaces of the tool. The profile shape of the tooth is formed by relative motion of the tool and workpiece during the generating roll.

Non-generating processes are those in which the profile shape of a tooth on a workpiece is produced directly from the profile shape on the tool. The tool is fed into the workpiece and the profile shape on the tool is imparted to the workpiece. No generating roll is employed.

Differential gears are usually straight-tooth bevel gears having a low number of teeth. Differential gears are usually coarse pitch (“pitch” is the distance between similar equally spaced tooth surfaces along a given line or curve), and usually have a pressure angle of about 25° or higher. The term “coarse pitch” is used when the number of teeth relative to the diameter of a gear is low. For example, 10 teeth on a gear having a diameter of 100 mm (module=100/10=10 mm) is considered to be coarse pitch, whereas 10 teeth on a gear having a diameter of 30 mm (module=30/10=3 mm) is considered to be fine pitch. The skilled artisan generally considers teeth (or gears) with a module lower than 5 mm to be “fine pitch” while teeth (or gears) having a module of 5 mm or more are considered to be “coarse pitch”.

FIG. 1 illustrates one example of a straight bevel differential gear 2 having a plurality of teeth 4 with each tooth having a topland 6, a root portion 8 and a pair of tooth flank surfaces 10. The region 11 between a pair of consecutive teeth is known as a tooth “slot” or “space” with the root portion 8 coinciding with the bottom of the tooth slot.

Differential gears have been cut by various methods. FIG. 2 illustrates straight bevel gear cutting with of a pair of inclined rotary disc cutters 12, 14 (commonly referred to and upper and lower cutters respectively) having cutting blades 16 for cutting a tooth slot in a workpiece 18. Cutter 12 is rotatable about axis 22 and cutter 14 is rotatable about axis 20. In a generating process on a conventional mechanical cradle-style machine, the inclined cutters 12, 14 are usually fed into the workpiece to a predetermined depth and a generating roll of the machine cradle (not shown) is commenced in a synchronized manner with rotation of the workpiece 18 to generate tooth profile surfaces 24, 26. The rotating cutting blades 16 effectively interlock to simultaneously cut the same tooth slot (e.g. U.S. Pat. No. 2,567,273).

FIGS. 3 and 4 illustrate an example of a tool and method for manufacturing straight bevel differential gears with a large circular cutter 30, for example, having a cutter diameter of 18, 21 or 25 inches (460, 535 or 635 mm). See, for example, U.S. Pat. No. 2,267,181, the entire disclosure of which is hereby incorporated by reference. The cutting blades 32 are oriented on the periphery of the cutter body 34, as seen in FIG. 3, and are grouped into roughing blades, semi-finishing blades and finishing blades. The cutter works in a single indexing process and only performs one revolution while cutting a complete tooth slot of a gear 38. The cutter is positioned at the toe end of the tooth slot and moves from toe to heel during a roughing and semi-finishing portion of the cycle in a conventional cutting process. When the cutter reaches the heel end of the tooth slot, all roughing and semi-finishing blades have been used. The cutter then moves back to the toe end in order to finish the tooth slot with the finishing blades in a climb cutting process. Between the last finishing blade and the first roughing blade is a larger space 36 which allows the machine to index the workpiece to the next tooth slot position without the need for the cutter to stop rotating and without the need for a cutter withdraw motion. The tool material is preferably high-speed-steel and the applied surface speed is usually between 20 and 40 m/min, which makes this cutting process a type of broaching process.

The fact that one cutter revolution finishes one slot and includes the indexing time, makes the above-discussed circular broaching process very fast. Compared to straight bevel gear cutting with a pair of inclined rotary cutting tools (FIG. 2) whose rotating cutting blades effectively interlock to simultaneously cut the same tooth slot with the same high-speed-steel tool material, the cutting times of the circular broaching process is only a fraction (e.g. 15 to 20%) of the interlocking rotary tools process.

A disadvantage of the circular broaching process is that the workpiece tooth profiles are formed in a profile cutting process which does not enable the creation of a precise octoid tooth form for a conjugate meshing with low motion error. Another disadvantage is the circular broach blade profiles are circular instead of involutes or an involute approximation. Yet another disadvantage of the circular broaching is that the process is missing the available freedoms for flank form corrections. Profile cutting with a circular blade profile produces a certain amount of length crowning (i.e. in the direction of the tooth length). The choice of the tooth surface profile curvature radius can produce a profile crowning. The profile (i.e. tooth height, root-to-tip direction) crowning has to be large enough to mask the kinematic inaccuracies which exist based on the profile cutting process. Fine tuning of tooth surfaces to optimize the rolling performance is nearly impossible without redefining the cutting-edge profiles and manufacturing a new cutter.

After heat treatment, the tooth surfaces of gears cut by the circular broaching process are not hard finished but are used with the distortions from the heat treatment process. This is sufficient for most practical applications. However, with the increasing demand for high power density and silent operation coming from manufacturers of electric vehicle drive trains, the need for a hard finishing operation is becoming a requirement in many applications.

Another manufacturing method for differential gears, which had its industrial breakthrough in the 1970's, is forging. In forging, a steel billet with temperatures in excess of 2,000° F. (1,093° C.) is pressed in a hard steel die. The die has the negative shape of the toothed side of a differential gear. The bore and back side of the forged parts are machined after the forging process. Some forging processes apply a calibration as a finishing process. The calibration is done after the forging to improve the surface finish as well as the tooth indexing quality. Today, forging achieves high quality differential gears in a very cost-effective manufacturing process. The advantages of forging are low manufacturing cost, the production of parts with a high integrity regarding bending and impacts, and the possibility to apply modifications like the placement of stiffening webs at the toe and heel root as seen in the gear set of FIG. 5, for example, comprising a pinion 40 and a side gear 42 (sometimes referred to as the “gear” member of a differential gear set). Some disadvantages are that the stiffening webs constrain the teeth from elastic bending which may lead in high load conditions to surface damage like pitting, and also to cracks in the tooth root. Additionally, with the presence of stiffening webs, the root lines are not straight or curved which makes it impossible to machine with any of the state-of-the-art gear machining processes. Machining would have to be carried out by a slow process using a ball nose endmill and a multi axis machining center for example.

Forged gears have a scale which is a thin outer layer with a higher hardness and a different steel structure. The forging scale also contributes to surface failure under high load. Forged gears have a certain variation of tooth thickness between the first and the last part of a die tool life. This variation results in a changing backlash after assembly which cannot be controlled. Forged differential gears at the beginning of the die tool life are too tight, which reduces the efficiency. Forged gears at the end of the die tool life have too much backlash, which leads to rattling noise and excessive drive train backlash.

Yet another method for manufacturing straight bevel differential gears is disclosed in U.S. Pat. No. 7,364,391, the entire disclosure of which is hereby incorporated by reference, and comprises a single side cutting process which roughs out and finish cuts all the first flanks of the teeth in a first step (FIG. 6(a) for example), and then changes the position of the cutter in order to finish cut all the second flanks of the teeth in a second step (FIG. 6(b) for example). The two-step process may be carried out on a computer-controlled multi-axis gear manufacturing machine such as that disclosed in U.S. Pat. No. 6,712,566, the entire disclosure of which is hereby incorporated by reference. The two-step process generates precise involutes (octoids) and allows for flank form modifications. After heat treatment it is possible to grind the differential gears with a CBN grinding process in a similar manner as cutting. The two-step process presents a variety of advantages compared to the above-discussed circular broaching or forging, in particular for differentials intended for electric vehicle drive trains. A disadvantage of the two-step process is, with respect to differential gears, lower productivity when compared to circular broaching or forging.

A suitable cutting tool for carrying out the above-discussed two-step process is illustrated in FIG. 7 which shows a peripheral cutting tool 50 removably secured to a spindle 48 of a machine tool (not shown) such as that disclosed in U.S. Pat. No. 6,712,566 for example. The cutting tool 50 comprises a cutter head 52 with a plurality of stick blades 54. A clamp block 56 is located above each stick blade. The cutter in FIG. 7 has a top ring 58 above the clamp blocks 56 with integrated clamp screws 59.

High power density and low rolling noise are major requirements for electric vehicle differential gears. The state-of-the-art differential gears, either cut with the circular broaching process, forged, or cut with the two-step process commonly have large profile crowning which results in a large motion error (300 μrad to 2,000 μrad) and a low effective contact ratio (ε_{γ} below 1.0).

### SUMMARY OF THE INVENTION

The invention is directed to a method of producing a tooth on a workpiece, the tooth having a tooth profile surface comprising a tip portion and a root portion, a toe end, a heel end, and a face width extending between the toe end and the heel end. The method comprises providing a gear cutting tool and rotating the gear cutting tool about an axis of rotation. The cutting tool and workpiece are engaged with one another and rolled together in accordance with a generating roll to generate a profile surface of a tooth. The generating roll comprises a first ratio-of roll and a second ratio-of-roll with the first and second ratios-of-roll being different from one another and with one of the first ratio-of-roll and the second ratio-of-roll resulting in a relief section being formed on the tooth profile surface.

### BRIEF DESCRIPTION OF THE DRAWINGS

FIG. 1 illustrates an example of differential gear.

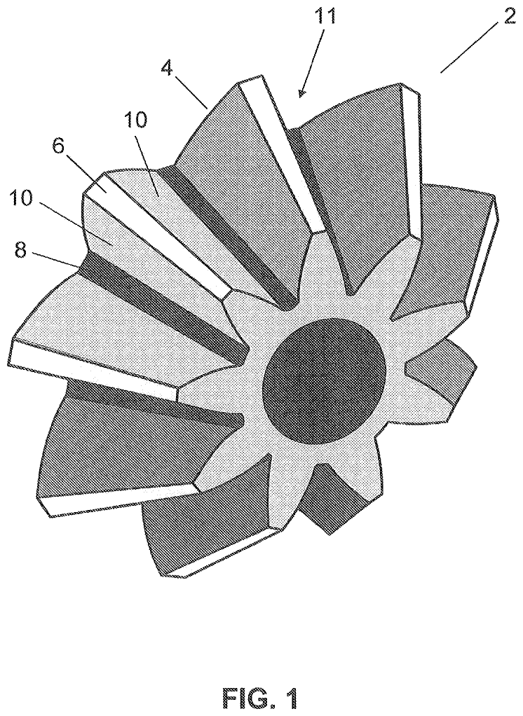

FIG. 2 shows the interlocking arrangement of a pair of inclined cutters cutting a tooth slot in a workpiece. is a view of a circular broach cutter which is in process of cutting a differential gear tooth slot.

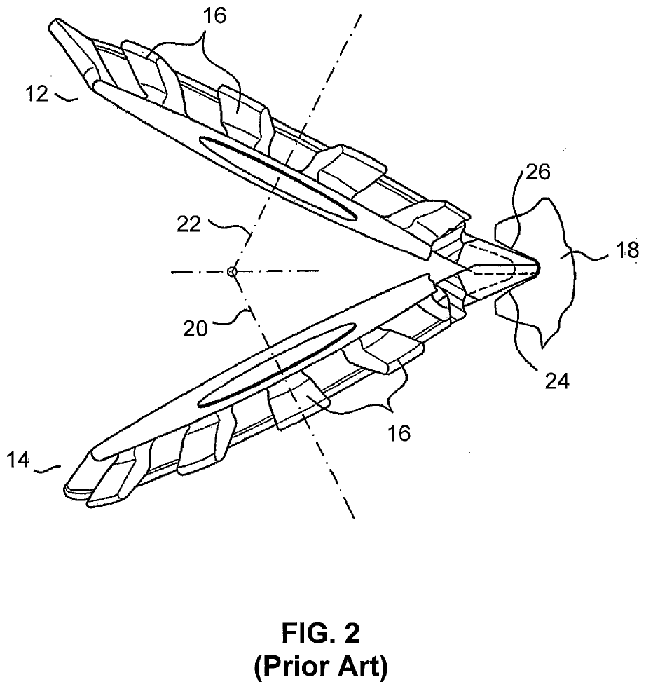

FIG. 3 shows a circular broach cutter.

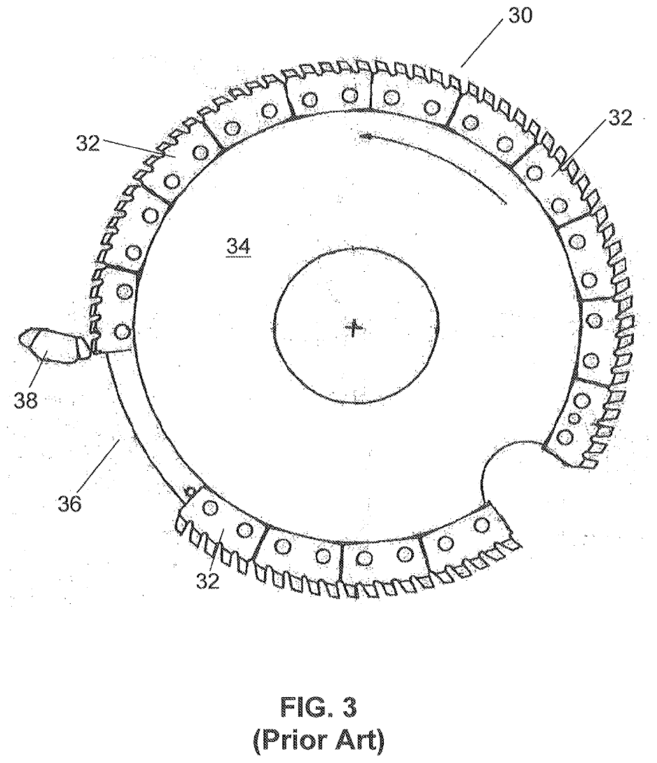

FIG. 4 is an image of a circular broach cutter cutting a differential gear slot.

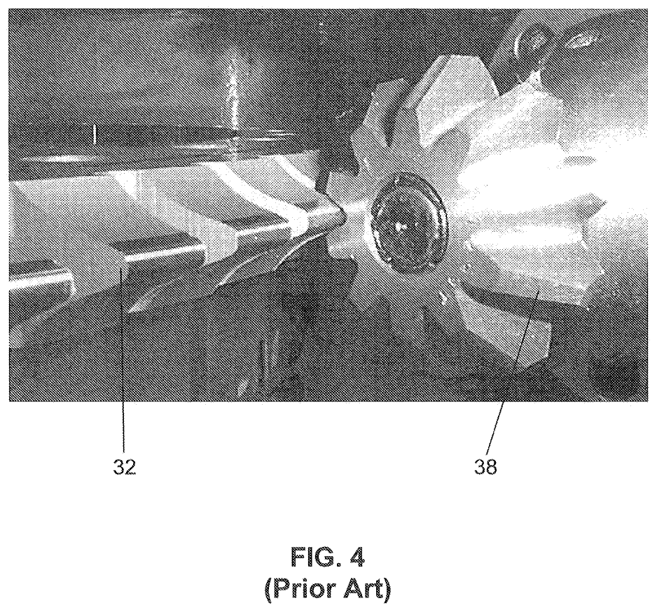

FIG. 5 illustrates a cross-sectional view of a forged differential gearset.

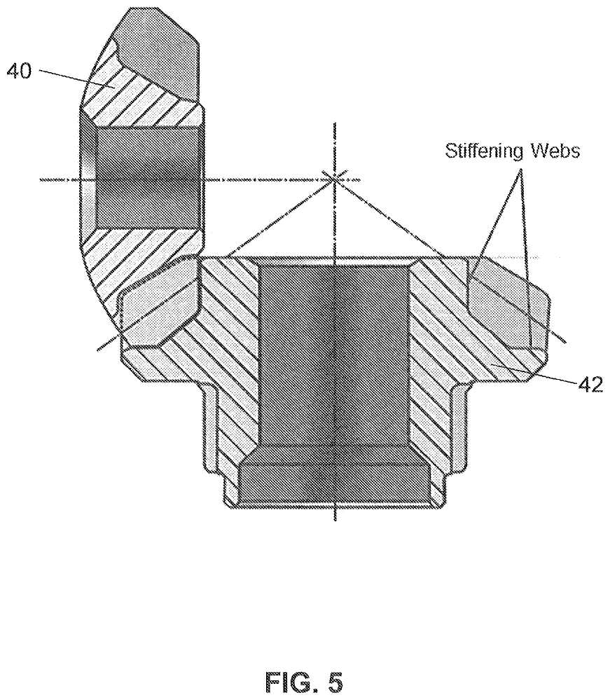

FIGS. 6(a) and 6(b) illustrate a two-step process for manufacturing straight bevel gears.

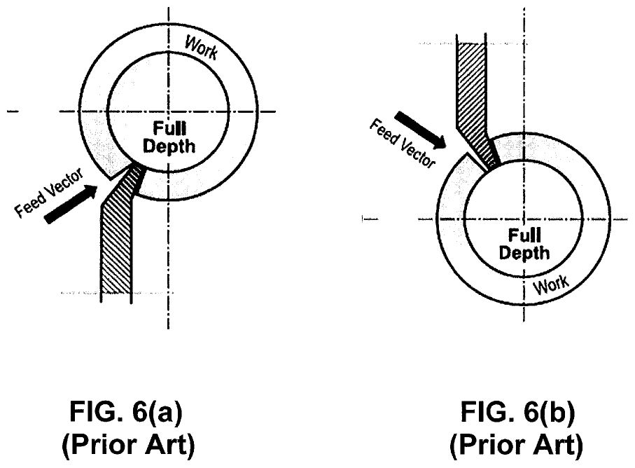

FIG. 7 shows a peripheral cutting tool for carrying out the two-step process of FIGS. 6(a) and 6(b).

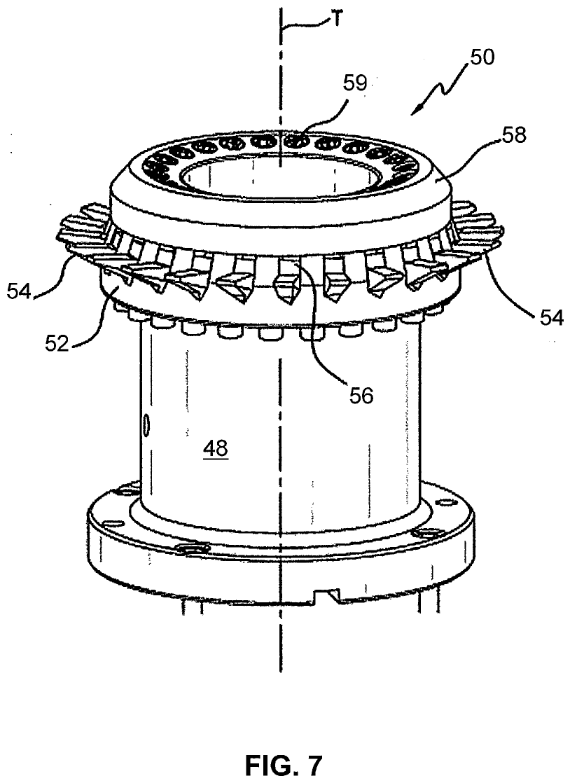

FIG. 8 shows an example of a motion error and tooth contact of a differential gear pair.

FIG. 9 illustrates contact analysis of a differential gear pair without profile crowning.

FIG. 10 shows a cutting blade profile with straight end modification.

FIG. 11 shows a cutting blade profile with curved end modification.

FIG. 12 illustrates contact analysis of a differential gear pair cut with blade end modification.

FIG. 13 shows a cutting blade profile with straight protuberance.

FIG. 14 shows a cutting blade profile with curved protuberance.

FIG. 15 illustrates contact analysis of a differential gear pair, cut with protuberance blades.

FIG. 16 shows a tooth tip modification with modified ratio-of-roll top section.

FIG. 17 illustrates contact analysis of a differential gear pair cut with a modified ratio of roll section.

### DETAILED DESCRIPTION OF THE PREFERRED EMBODIMENT

The terms “invention,” “the invention,” and “the present invention” used in this specification are intended to refer broadly to all of the subject matter of this specification and any patent claims below. Statements containing these terms should not be understood to limit the subject matter described herein or to limit the meaning or scope of any patent claims below. Furthermore, this specification does not seek to describe or limit the subject matter covered by any claims in any particular part, paragraph, statement or drawing of the application. The subject matter should be understood by reference to the entire specification, all drawings and any claim below. The invention is capable of other constructions and of being practiced or being carried out in various ways. Also, it is understood that the phraseology and terminology used herein is for the purposes of description and should not be regarded as limiting.

The details of the invention will now be discussed with reference to the accompanying drawings which illustrate the invention by way of example only. In the drawings, similar features or components will be referred to by like reference numbers. The size and relative sizes of certain aspects or elements may be exaggerated for clarity or detailed explanation purposes.

The use of “including”, “having” and “comprising” and variations thereof herein is meant to encompass the items listed thereafter and equivalents thereof as well as additional items. The use of letters or numbers to identify elements of a method or process is simply for identification and is not meant to indicate that the elements should be performed in a particular order. As used herein, the singular forms “a”, “an” and “the” are intended to include the plural forms as well, unless the context clearly indicates otherwise and the term “and/or” includes any and all combinations of one or more of the associated listed items.

Although references may be made below to directions such as upper, lower, upward, downward, rearward, bottom, top, front, rear, etc., in describing the drawings, these references are made relative to the drawings (as normally viewed) for convenience. These directions are not intended to be taken literally or limit the present invention in any form. In addition, terms such as “first”, “second”, “third”, etc., are used to herein for purposes of description and are not intended to indicate or imply importance or significance unless explicitly stated.

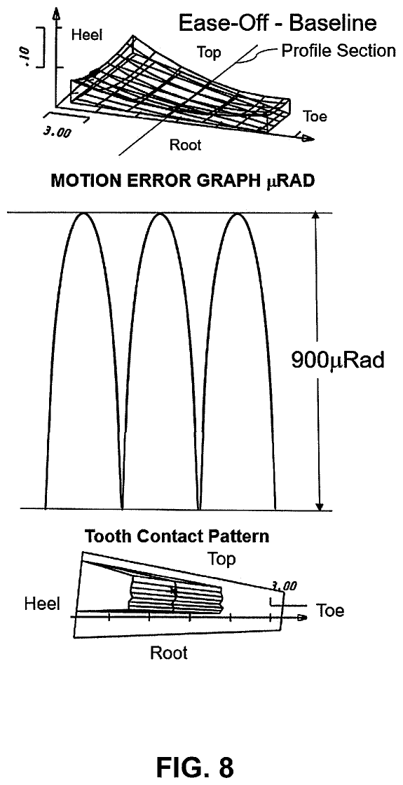

FIG. 8, at top, shows an Ease-Off graph of one example of a state-of-the-art differential gear pair. The Ease-Off represents tooth flank form modifications like length crowning and profile crowning which are required in order prevent edge contact under load and in case of deflections and manufacturing tolerances. The Ease-Off magnitudes along the labeled profile section represent the profile crowning of this example gearset. This profile crowning is equivalent to the motion error which is shown in the center of FIG. 8. The motion error is represented by the three consecutive parabolas (representing three consecutive pair of teeth meshing). The rated motion error value is the distance from the top line to the intersection of the parabolas. In the present example, the rated motion error is 900 μrad. The large motion error in turn increases operating noise and reduces the power density. In order to reduce the motion error, the profile crowning must be reduced which will create a nearly conjugate profile. The tooth contact pattern is shown below the motion error graph. The tooth contact is located central between the heel end and toe end of the tooth.

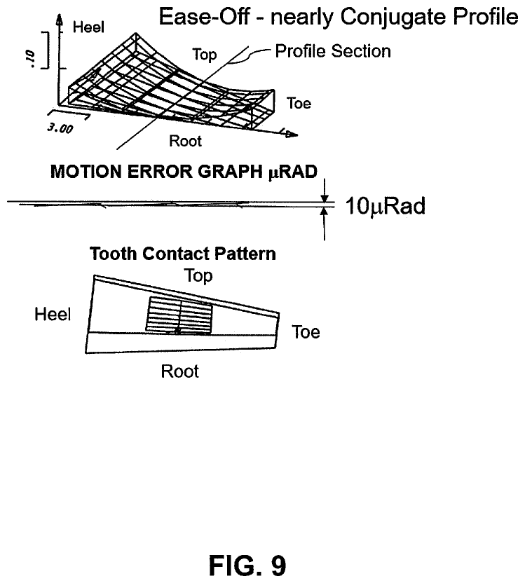

FIG. 9, at top, shows an Ease-Off graph of a differential gear pair with a nearly conjugate profile section. The profile was intentionally made to be not exactly conjugate in order to provide a small amount of profile crowning. A conjugate tooth profile has no crowning in the profile direction which will result in zero motion error. The nearly conjugate profile in FIG. 9 results in a 10 μrad motion error. The lack of meaningful Ease-Off on the tooth profile of FIG. 9 will result in edge contact at the toplands of pinion and gear under load and in case of deflections. The bottom portion of FIG. 9 shows the tooth contact pattern.

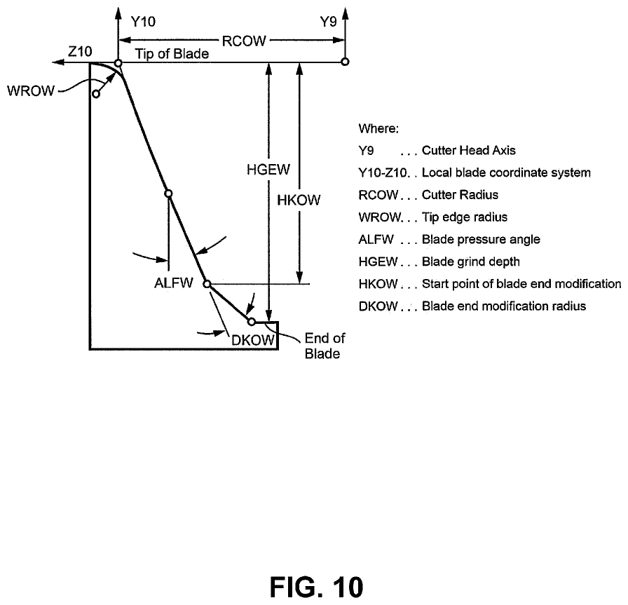

In order to avoid the edge contact between meshing teeth, a tip relief on the pinion teeth and on the gear teeth can be implemented. A cutting blade with a straight end modification as shown in FIG. 10 can be applied to achieve the tip reliefs. FIG. 10 shows a cutting edge profile with the blade tip on top and the blade end at the bottom. The end modification starts at HKOW from the tip and has an angle DKOW. Starting point HKOW and blade modification angle DKOW are chosen to realize the desired tip relief on the cut teeth. An example of a suitable machine for grinding cutting blades to produce the discussed modifications is the Blade Profile Grinding Machine (BPG) commercially available from The Gleason Works, Rochester, New York.

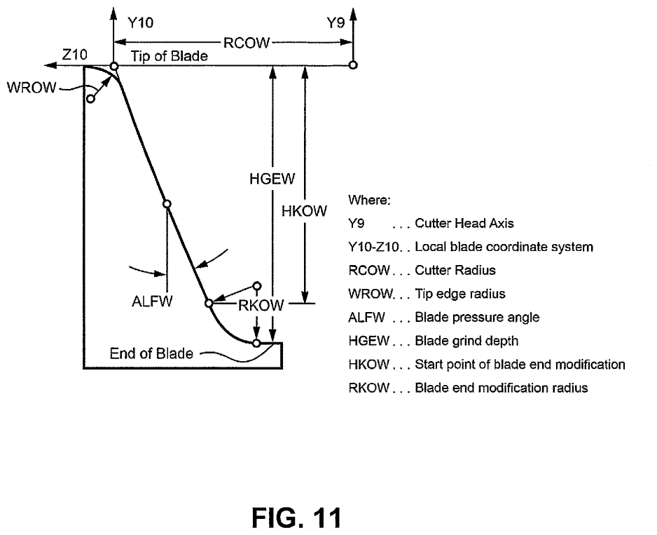

A circular end modification as shown in FIG. 11 is also possible. The end modification has a starting point (at HKOW from the blade tip) and a blade modification radius RKOW. Starting point HKOW and blade modification radius RKOW are chosen to realize the desired tip relief on the cut teeth.

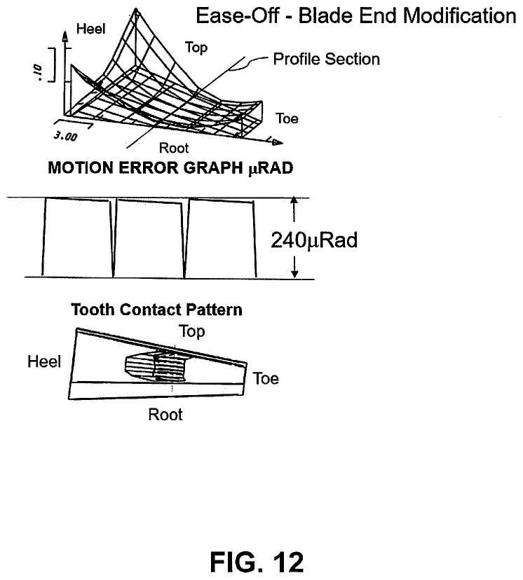

FIG. 12, at top, shows the Ease-Off graph of a differential gear pair with a blade end modification of the pinion cutting blade and gear cutting blade. Because the blade tip follows the root line of the respective gear, and because the top of the differential gear (face angle) is tapered versus the root line because of the tapered-depth teeth of straight bevel gears, the pinion blade end modification generates a relief section which is large at the heel and reduces its magnitude towards the toe (compared to FIG. 9). Between center and toe there is a location where the modification is zero. The relief at the top of the Ease-Off is created by the gear cutting blade and the relief at the root is created by the pinion cutting blade. The motion error in the center of FIG. 12 is 240 μrad because the profile section “cuts” through a part of the relief area. The bottom graph shows the tooth contact pattern.

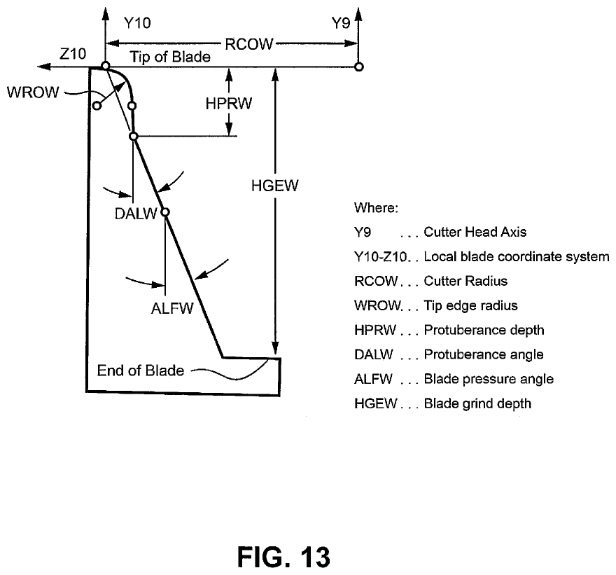

Another method to create reliefs at the tip and root end of the Ease-Off is the use of blades with a protuberance as shown in FIG. 13 which shows the profile of a cutting blade with a straight protuberance. The protuberance has a starting point (at HPRW from the blade tip) and a protuberance angle DALW with respect to the cutting edge. Starting point HKOW and protuberance angle DALW are chosen to realize the desired root relief on the cut teeth.

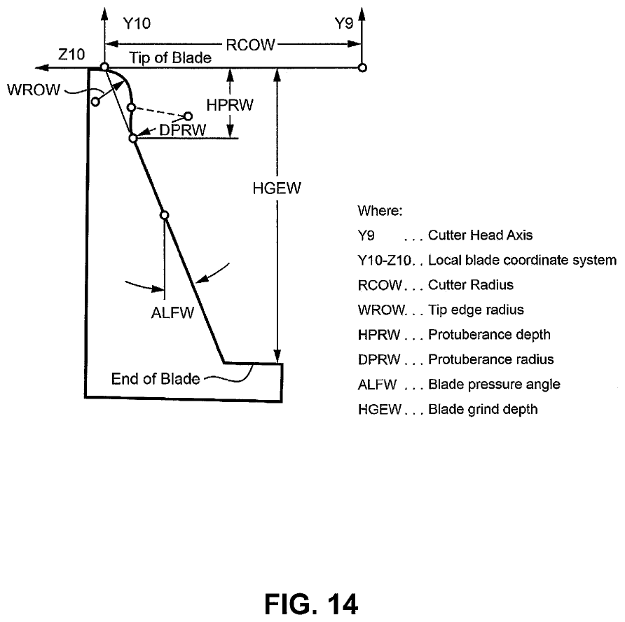

It is also possible to apply a curved protuberance as shown in FIG. 14 which shows the profile of a cutting blade with a circular protuberance. The protuberance has a starting point (at HPRW from the blade tip) and a protuberance radius DPRW. Starting point HKOW and protuberance radius DPRW are chosen to realize the desired root relief on the cut teeth.

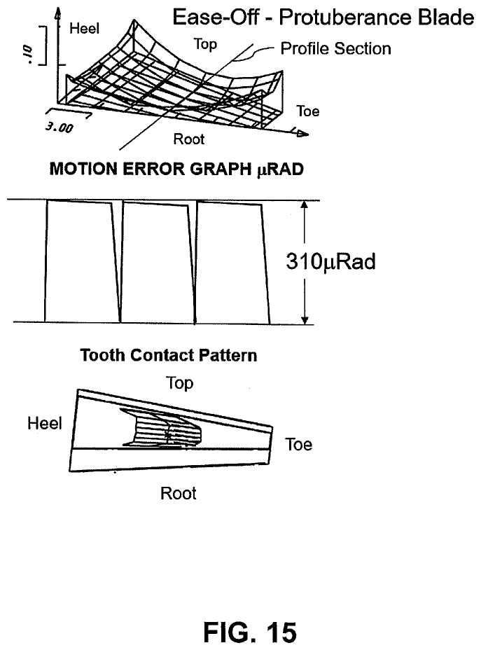

The protuberance delivers a nearly uniform relief along the face width at both sides of the Ease-Off as shown in FIG. 15 (compared to FIG. 9). However, root relief is not desirable because it weakens the roots of the teeth and reduces the power density. The motion error created by the protuberance blade is 310 μrad. All blade modifications, like blade end relief and protuberance, require complex blade profile modifications which are custom developments for one specific gear set design. Blade or cutter head consolidations, as commonly done for straight bevel gears, would not be possible after job design specific blade modifications (end relief or protuberance) have been done.

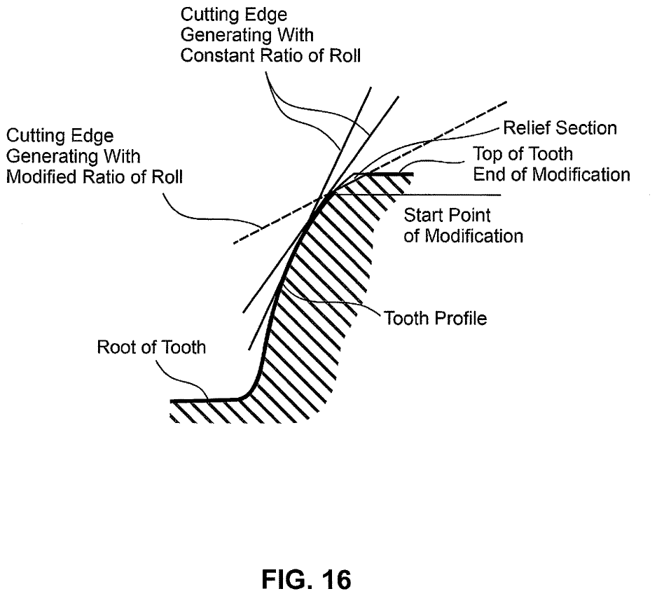

FIG. 16 shows a cross-sectional view of a differential gear profile. The straight lines symbolize the cutting-edge profile of the cutting blades, which is straight, without any modifications. The two solid lines represent cutting blades generating the tooth profile with the correct (i.e. theoretical) ratio-of-roll for the particular tooth. “Ratio-of-roll” is the ratio of the number of teeth in the theoretical generating gear to the number of teeth in the gear being cut. At the starting point of the tip relief, the ratio-of-roll changes and the dashed line shows the effect of the modified ratio-of-roll with the marked relief section. The tooth profiles of straight bevel gears (e.g. involute) are commonly generated with a constant ratio-of-roll. The inventive method is based on a change from a constant ratio-of-roll to a modified ratio-of-roll at a certain roll position.

FIG. 16 shows schematically how the cutting blade profile generates an involute tooth profile with a first (e.g. constant) ratio-of-roll (solid cutting edge lines) and how it generates a tip relief with a second (e.g. modified) ratio-of-roll (dashed cutting edge line). The “modified” second ratio-of-roll being a modification with respect to the first ratio-of-roll. The modified ratio-of-roll begins at the start point of modification (FIG. 16) and it ends at the top of the tooth (or slightly above, at the roll position, where the machine kinematic ends the generating roll. This end position is often called the start roll position when the machining process moves the cutter blades roll from the top to the root. Both rolling from root-to-top or from top-to-root is possible within the available cutting processes. The modified ratio-of-roll can either be constant (different than the constant first ratio-of-roll) or it can be calculated depending on the roll position as a higher order function. For example, the respective polynomial can be written as a Taylor Series development:

$$RA = RA 0 \cdot \{ 1 - ( c / 2 ! ) \cdot Δ q - ( d / 3 ! ) \cdot Δ {q}^{2} - ( e / 4 ! ) \cdot Δ {q}^{3} - ( f / 6 ! ) \cdot Δ {q}^{4} … \} Δ q = q - {q}_{T} If ( {q}_{S} < {q}_{T} ) \to \{ {q}_{S} \leq q \leq {q}_{T} \} \\ If ( {q}_{S} > {q}_{T} ) \to \{ {q}_{T} \leq q \leq {q}_{S} \} \qquad ( 1 )$$

Where:
RA . . . Effective ratio of roll [-]
RA0 . . . Base ratio of roll [-]
c . . . First order coefficient [1/(°)]
d . . . second order coefficient) [1/(°)²]
e . . . third order) coefficient [1/(°)³]
f . . . fourth order) coefficient [1/(°)⁴]
Δq . . . ratio of roll difference [°]
q . . . Actual roll position [°]
q_{T} . . . Tip relief start position [°]
q_{S} . . . Top roll position (tip relief end position) [°]

Alternatively, for example, the modified ratio-of-roll may be determined by general higher order polynomials, spline functions, circular functions or elliptical functions.

The tip relief start position and the magnitude of the coefficients are either calculated or found experimentally in order to create the desired amount of relief within the desired area.

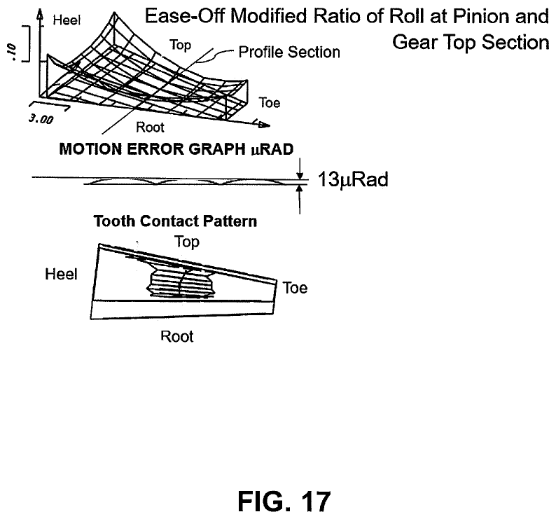

FIG. 17 shows on top the Ease-Off graphic of a differential gear pair (i.e. gear member and pinion member) which was manufactured with a modified ratio-of-roll section. The relief on top of the Ease-Off graphic is the result of the gear member tip relief and the relief at the root of the Ease-Off graphic is the result of the pinion member tip relief. The reliefs are larger at the heel and smaller at the toe, but they exist along the entire face width. The change of the relief magnitude along the width of the tooth is caused by the direction of the generating marks, which have a slightly different angle than the face angle of the respective member. In connection with straight bevel gears this has a practical advantage because it creates a small motion error and yet provides good protection against edge contact towards the heel. Under high load, the contact extends towards the heel. The modified ratio-of-roll sections provide the ideal combination of quiet rolling differential gears under low load and edge contact prevention under low and high loads.

A result of a tip relief on the pinion and gear teeth is shown in FIG. 17 (compared to FIG. 9). The reliefs are nearly uniform and appear similar to the protuberance reliefs in FIG. 15. The created motion error is 13 μrad. The advantage of the tip relief, which is larger towards the heel and smaller towards the toe, is that the contact area moves to the heel as load is applied and therefore more relief amount at the heel is desirable. This ensures that the relief amount at midface leads to a low motion error magnitude. The advantage of a tip relief versus a root relief (protuberance) is that no weakening of the root is created and that the modified ratio-of-roll will not require any costly blade modification and can be optimized or changed just by changing the respective machining parameters. The bottom graphic shows the tooth contact pattern for this example.

While the inventive method has been discussed and illustrated with reference to gear tooth tip relief, the invention is equally applicable to the generation of gear tooth root relief. Additionally, the modified ratio-of-roll may be further modified by adjustment of machine settings during the generating roll including cutter tilt, swivel and/or cutter reference height. For example, a defined second order combination of cutter tilt and swivel may be utilized to bring about a twisting motion of the cutter so as to balance the relief effect between the heel and toe on a tooth.

Furthermore, the inventive method also contemplates grinding. A grinding wheel is considered to be a cutting tool with undefined cutting edges.

While the invention has been described with reference to preferred embodiments it is to be understood that the invention is not limited to the particulars thereof. The present invention is intended to include modifications which would be apparent to those skilled in the art to which the subject matter pertains without deviating from the spirit and scope of the appended claims.

What is claimed is:

1. A method of producing a tooth on a workpiece, said tooth having a tooth profile surface comprising a tip portion and a root portion, a toe end, a heel end, and a face width extending between the toe end and the heel end, said method comprising:
rotating a gear cutting tool about an axis of rotation,
engaging said cutting tool and said workpiece,
rolling said cutting tool with said workpiece together in accordance with a generating roll to generate a profile surface of the tooth,
wherein said generating roll comprises a first ratio-of roll and a second ratio-of-roll with the first and second ratios-of-roll being different from one another and with one of said first ratio-of-roll and said second ratio-of-roll resulting in a relief section being formed on said tooth profile surface.

2. The method of claim 1 wherein said relief section comprises a relief section at the tip portion of the tooth profile surface.

3. The method of claim 1 wherein said relief section comprises a relief section at the root portion of the tooth profile surface.

4. The method of claim 1 wherein the first ratio-of-roll is a constant.

5. The method of claim 1 wherein the second ratio-of-roll is a constant.

6. The method of claim 1 wherein one of said first ratio-of-roll and said second ratio-of-roll is defined as a higher order function.

7. The method of claim 1 wherein the tooth profile surface is an involute.

8. The method of claim 1 wherein the relief section extends along the entire face width of said tooth.

9. The method of claim 1 wherein the relief section is larger at the heel end of the tooth than at the toe end of the tooth.

10. The method of claim 1 wherein the gear cutting tool comprises a grinding wheel or a plurality of cutting blades.

11. The method of claim 1 wherein said one of said first ratio-of-roll and said second ratio-of-roll resulting in a relief section being formed on said tooth profile surface is further modified by adjustment of machine settings during the generating roll.

12. The method of claim 11 wherein said machine settings comprise at least one of cutter tilt, cutter swivel and cutter reference height.

13. The method of claim 1 wherein said workpiece comprises at least one of a gear member and pinion member of a gear pair.
